(19) United States
(12) Patent Application Publication
(10) Pub. No.: US 2007/0090203 A1
(43) Pub. Date: Apr. 26, 2007

(54) Wheeled concrete supply hose moving device

(76) Inventors: Philip J. Quenzi, Atlantic Mine, MI (US); Mark A. Pietila, Atlantic Mine, MI (US); Timothy E. Ruonavaara, Calumet, MI (US); Michael R. Keranen, Howell, MI (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 11/585,696

(22) Filed: Oct. 24, 2006

Related U.S. Application Data
(60) Provisional application No. 60/730,056, filed on Oct. 25, 2005.
(60) Provisional application No. 60/839,038, filed on Aug. 21, 2006.

(51) Int. Cl. A01G 25/09; B65H 75/00; B05B 3/18; B05B 9/03

(52) U.S. Cl. 239/197; 239/722; 239/146; 239/195

(57) ABSTRACT

A wheeled hose moving device is movable over a support surface and is operable to grasp and lift and move a concrete supply hose at the support surface. The wheeled device includes a wheeled support and a hose grasping device movably supported by the wheeled support. The hose grasping device includes a pair of arms that are generally vertically movable relative to the frame portion and that are movable relative to one another. The wheeled support is positionable generally at a concrete supply hose and the hose grasping device is lowerable to a level generally at the concrete supply hose. The arms are movable to engage and grasp the concrete supply hose, and the hose grasping device is operable to lift the grasped concrete supply hose, whereby the grasped and lifted concrete supply hose is movable over the support surface by the wheeled support.

### CROSS REFERENCE TO RELATED APPLICATIONS

The present application claims the benefit of U.S. provisional applications, Ser. No. 60/730,056, filed Oct. 25, 2005; and Ser. No. 60/839,038, filed Aug. 21, 2006, which are hereby incorporated herein by reference in their entireties.

### FIELD OF THE INVENTION

The present invention relates generally to concrete placing devices and, more particularly, to devices for placing concrete via one or more concrete supply hoses that provide a conduit for directing uncured concrete to a targeted location.

### BACKGROUND OF THE INVENTION

Typically, uncured concrete may be conveyed or conduited from a source or supply, such as a truck or the like, to a targeted placing location, where the uncured concrete is discharged onto the targeted area via a discharge device or nozzle. The uncured concrete is often pumped into a flexible concrete supply hose that may be laid along the ground or subgrade surface between the concrete supply or source and the discharge device. As the discharge device is moved over the targeted area, the supply hose must also be moved to accommodate the movement of the discharge device relative to the concrete source. Also, as the discharge device is moved toward the concrete source, sections of the hose may be removed to shorten the supply hose or conduit between the concrete source and the discharge device. Such movement and removal of the hose and hose sections is often highly labor intensive, since the hose and/or hose section typically has uncured concrete therein and, thus, is quite heavy for a person or persons to lift and/or move over the ground or subgrade surface.

Therefore, there is a need in the art for a device and/or method that moves the concrete supply hose or sections of hose and requires less manual labor and thus overcomes the shortcomings of the prior art.

### SUMMARY OF THE INVENTION

The present invention provides a concrete supply hose moving device that includes a wheeled frame or unit and at least one hose grasping device for grasping and lifting a concrete supply hose or section of hose, whereby the wheeled unit may readily move the concrete supply hose or section of hose to a desired location.

According to an aspect of the present invention, a wheeled hose moving device is movable over a support surface and is operable to grasp and lift and move a concrete supply hose at the support surface. The wheeled device includes a wheeled support and a hose grasping device movably supported by the wheeled support. The wheeled support includes a frame portion and a pair of wheels rotatably mounted at the frame portion. The hose grasping device includes a pair of grasping arms or elements that are generally vertically movable relative to the frame portion and that are movable relative to one another. The wheeled support is positionable generally at a concrete supply hose and the hose grasping device is lowerable to a level generally at the concrete supply hose. The arms are movable to engage and grasp the concrete supply hose, and the hose grasping device is operable to lift the grasped concrete supply hose, whereby the grasped and lifted concrete supply hose is movable over the support surface by the wheeled support.

The wheeled support may be selectively movable in a forward direction and a rearward direction, and may be powered, such as via one or more hydraulic motors. The hose grasping device may be vertically movable via an actuator or the like, such as via extension and retraction of a hydraulic cylinder or the like, and the arms or sections may be pivoted or moved via extension and retraction of another actuator or hydraulic cylinder or the like. The wheeled support may include two hose grasping devices, with each pair or set of arms being at or near an opposite end portion of the frame portion and at an opposite side of the wheels of the wheeled support. Optionally, the hose grasping device may be pivotable about a generally vertical pivot axis to adjust an orientation of the grasping arms or elements relative to the frame of the hose moving apparatus or device.

The wheels of the wheeled support are preferably steerable, such as by pivoting about a respective generally vertical axis at the frame portion to steer the wheeled support over the support surface. The frame portion of the wheeled support may include an upper frame portion that is pivotally attached to a lower frame portion, with the wheels being rotatably mounted to the lower frame portion. The pivotal movement of the upper frame portion relative to the lower frame portion may impart a pivotal movement of the wheels about their respective generally vertical axes to steer the wheeled support.

According to another aspect of the present invention, a method for grasping and lifting and moving a concrete supply hose at a support surface includes providing a wheeled device having a wheeled support and a hose grasping device movably supported by the wheeled support. The wheeled support includes a frame portion and a pair of wheels rotatably mounted at the frame portion. The hose grasping device includes a pair of arms that are generally vertically movable relative to the frame portion and that are movable relative to one another. The wheeled support is positioned at an initial location that is generally at a concrete supply hose and the hose grasping device is lowered to a level generally at the concrete supply hose. The arms are moved to engage and grasp the concrete supply hose, and the hose grasping device and the grasped concrete supply hose are lifted above the support surface. The wheeled support is moved over the support surface to move the grasped and lifted concrete supply hose over the support surface, and the concrete supply hose is lowered and released at a location that is remote from the initial location.

Therefore, the present invention provides a concrete supply hose moving device or apparatus that may be readily moved or driven or controlled to a location at a concrete supply hose or section of hose, and that may readily grasp and lift the hose or section of hose. The wheeled support may be powered to move the grasped and lifted hose to a new or targeted location. The hose moving device thus may readily lift and move a concrete supply hose or section of hose with little manual labor or effort on the part of the operator of the hose moving device. The wheeled hose moving device of the present invention thus provides an enhanced means for moving a concrete supply hose to adjust the routing or position or length of the concrete supply hose while reducing or limiting the manual labor typically associated with the moving of such hoses or sections of hose.

These and other objects, advantages, purposes and features of the present invention will become apparent upon review of the following specification in conjunction with the drawings.

### BRIEF DESCRIPTION OF THE DRAWINGS

FIG. 1 is a perspective view of a wheeled hose moving device in accordance with the present invention, shown with an operator controlling the moving device;

FIG. 2 is another perspective view of the wheeled hose moving device of the present invention;

FIG. 3 is a lower perspective view of the wheeled hose moving device of FIG. 2;

FIG. 4 is a side elevation of the wheeled hose moving device of FIGS. 2 and 3;

FIG. 5 is a top plan view of the wheeled hose moving device of FIGS. 2-4;

FIG. 6 is an end elevation of the wheeled hose moving device of FIGS. 2-5;

FIG. 7 is an enlarged perspective view of a grasping and lifting device of the wheeled hose moving device of the present invention;

FIG. 8 is a perspective view of the grasping and lifting device of FIG. 7, shown in its lowered position;

FIG. 9 is a perspective view of another wheeled hose moving device in accordance with the present invention, with a pivotable grasping and lifting device;

FIG. 10 is another perspective view of the wheeled hose moving device of FIG. 9, shown with different tires;

FIGS. 11A-F are views of the grasping and lifting device of the wheeled hose moving device of the present invention;

FIGS. 12A and 12B are perspective views of the grasping and lifting device of FIGS. 11A-F, shown with the grasping elements in the extended or lowered position;

FIG. 13A is an end elevation of another grasping and lifting device of the present invention, with a portion of the mounting bracket removed to show additional details;

FIG. 13B is a perspective view of the grasping and lifting device of FIG. 13A;

FIG. 14 is a lower perspective view of the wheeled hose moving device of FIG. 9;

FIG. 15 is a top plan view of the wheeled hose moving device of FIG. 9;

FIG. 16 is an end elevation of the wheeled hose moving device of FIG. 9;

FIG. 17 is an opposite end elevation of the wheeled hose moving device of FIG. 16;

FIG. 18 is a side elevation of the wheeled hose moving device of FIG. 9;

FIG. 19 is a perspective view of a control panel of the wheeled hose moving device of the present invention;

FIG. 20 is a plan view of a cover plate or label for the control panel of FIG. 19;

FIG. 21 is a rear perspective view of a wheeled hose moving device grasping and moving a section of concrete supply hose in accordance with the present invention; and

FIG. 22 is a front perspective view of the wheeled hose moving device of FIG. 21.

### DESCRIPTION OF THE PREFERRED EMBODIMENTS

Referring now specifically to the drawings and the illustrative embodiments depicted therein, a wheeled hose moving device or apparatus or machine 10 is operable to grasp and move a concrete supply hose or section of hose. The wheeled hose moving device 10 includes a wheeled support or base unit 12 and at least one hose grasping and lifting device or mechanism or apparatus 14 that is movably supported by wheeled support unit 12. Hose grasping and lifting device 14 includes a grasping device 16 (in the illustrated embodiment, wheeled hose moving device 10 includes two grasping devices 16, one at or near each end of the wheeled support unit 12), which is generally vertically movable (such as via an elevation device 18) and is adjustable to engage and grasp a concrete supply hose and to lift or raise or generally vertically move the concrete supply hose, as discussed below. The wheeled support unit 12 may be driven and steered by an operator walking behind the wheeled unit to move the lifted concrete supply hose to a desired or appropriate or targeted location, as also discussed below.

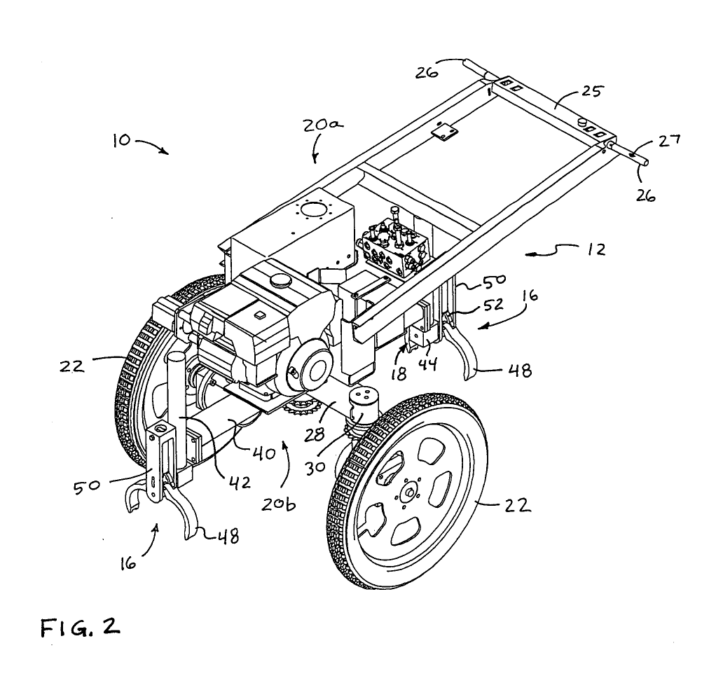

Wheeled support unit 12 includes a frame portion 20 supported by a pair of rubber-tired wheels 22. The wheels may be rotatably driven via respective drive motors 24, such as hydraulic motors or the like, to provide driving of the apparatus over and through the uncured concrete or subgrade materials. The drive motors 24 may be actuated and deactuated and controlled via a user input or control at a control panel 25 and/or handlebars 26 of the wheeled support unit 12. Desirably, the wheeled support unit 12 includes a stop switch or kill switch 27 (FIG. 2) at one or both of the handlebars 26, which functions to stop operation of the drive motors 24 when the operator releases the switch 27, such that wheeled support unit 12 cannot be powered or driven without the operator's hand or hands on the handlebar 26.

Wheeled support unit 12 includes a power source, such as a gasoline powered engine or the like, and a hydraulic control system for controlling operation of hydraulic motors and hydraulic actuators and/or the like. The frame portion 20 may comprise an upper frame portion 20a (which may support the power source and may have a handlebar frame extending therefrom) and a lower frame portion 20b. The upper frame portion 20a may pivot about a generally vertical axis 20c relative to the lower frame portion 20b, such as for steering the wheeled support unit, as discussed below.

In the illustrated embodiment, lower frame portion 20b includes a generally horizontal cross member 28 and a pair of generally vertical wheel support or mounting posts or members 30. The wheels 22 and motors 24 are mounted to the respective generally vertical posts 30, such as by utilizing aspects of the wheeled devices described in U.S. Pat. Nos. 6,588,976 and 6,623,208, which are hereby incorporated herein by reference in their entireties. The drive motors and wheels may be independently driven and/or correspondingly driven and/or differentially driven, such as to assist in controlling and/or steering the wheeled support unit 12 as it is driven and moved over the surface. For example, the drive motors may comprise hydraulic motors that are powered via a hydraulic pump and solenoids or control valves, and which may be differentially powered so as to adjust the power or pressure at each drive motor so as to limit slippage of one or both of the wheels as the wheeled support unit is driven along the support surface and/or over the concrete supply hose at the support surface.

The wheeled support unit may be steered by an operator as the wheeled support unit is driven or powered along and over the ground or support surface. The wheels 22 may be steered or turned via correspondingly pivoting the wheels and motors about their respective generally vertical pivot axes 30a defined by posts 30 to turn the wheels relative to the cross member 28 of lower frame portion 20b. For example, the wheels 22 of wheeled support unit 12 may be turned or steered relative to the lower frame portion 20b in response to an operator turning the handlebar 26 of upper frame portion 20a in the desired direction.

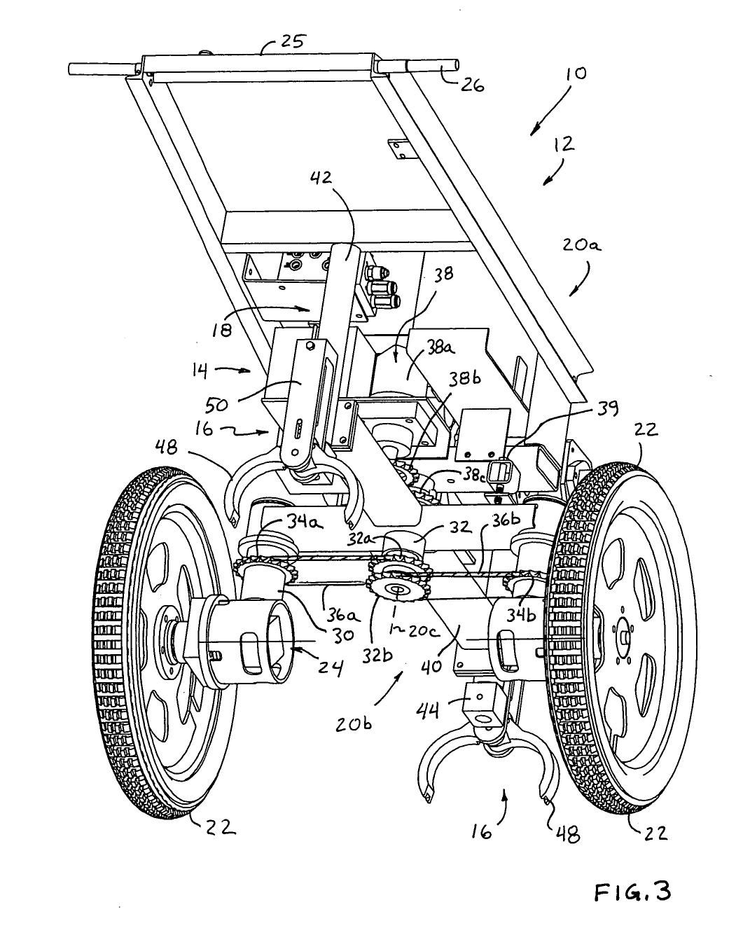

In the illustrated embodiment (and as can be seen with reference to FIG. 3), the pivotal movement of the handlebars 26 and upper frame portion 20a relative to lower frame portion 20b (such as about the vertical pivot axis 20c) causes a corresponding pivotal movement or rotation of a generally vertical pivot axle 32, which extends downwardly from upper frame portion 20a and through or at cross member 28 of lower frame portion 20b. The pivot axle 32 includes a pair of steering sprockets 32a, 32b, which are located generally below cross member 28 and at a level of a respective sprocket 34a, 34b at the posts 28. A chain or flexible drive member 36a, 36b is interconnected between a respective steering sprocket 32a, 32b and post sprocket 34a, 34b, such that rotation of the pivot axle 32 and sprockets 32a, 32b (via pivotal movement of upper frame portion 20a) causes a corresponding rotation of the respective post sprocket 34a, 34b. Thus, the pivotal movement of the handlebars 26 and upper frame portion 20a in either direction imparts a corresponding rotation or turning of the wheels and motors relative to the lower frame portion 20b.

Optionally, and as also shown in FIG. 3, a steering assist device or mechanism 38 may be provided to assist the operator in turning the wheels of the wheeled support unit 12. In the illustrated embodiment, steering assist device 38 (FIG. 3) includes a rotational drive motor 38a (such as a hydraulic motor or the like) and an output gear or sprocket 38b of the drive motor 38a, which engages a sprocket or gear 38c of the pivot axle 32. Thus, as the upper frame portion 20a is pivoted by an operator relative to lower frame portion 20b to turn the wheels of the wheeled support unit 12, the rotational drive motor 38a may activate to assist in rotating the pivot axle 32 to assist the operator in turning the wheeled support unit 12. The rotational drive motor 38a may be activated in response to any triggering means or device or element or action or event, such as, for example, in response to a user input at the control panel 25 or in response to a detection of an initial or threshold pivotal movement of the upper frame portion (such as by a sensor or the like at the wheeled support unit) or in response to a detection of an initial or threshold force or resistance to the pivotal movement of the upper frame portion or the wheels (such as by a force sensor at the frame portion or at the wheel support posts or the like) or in response to any other actuating means or sensing means or the like, while remaining within the spirit and scope of the present invention.

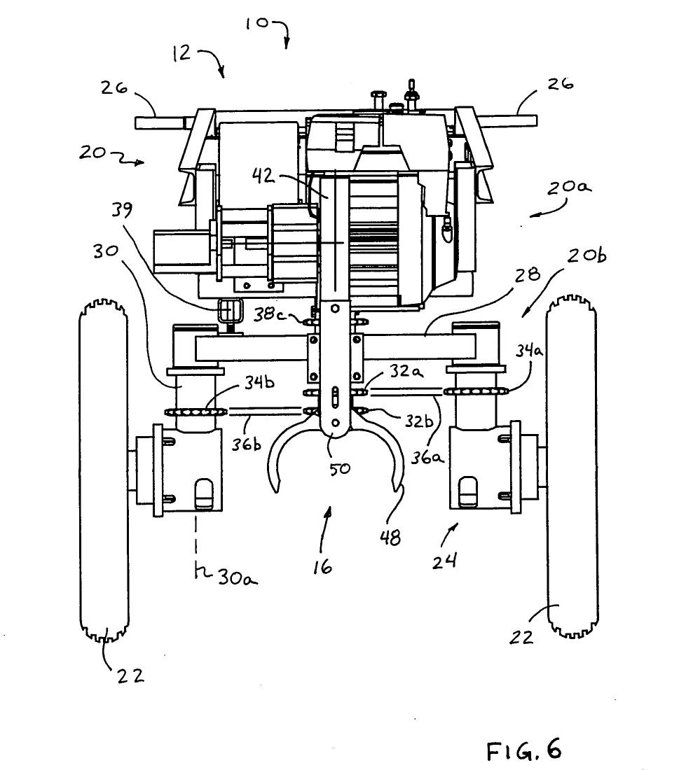

Optionally, wheeled support unit 12 may include a locking pin or element 39 (FIGS. 3 and 6) that may be insertable through one or more openings in the upper and lower frame portions to limit or substantially preclude pivotal movement of the upper frame portion 20a relative to the lower frame portion 20b. The locking pin or element 39 may be manually inserted or applied to the frame portion, or the locking element 39 may be biased (such as via a spring or the like) toward or into an engaged position, whereby the locking element 39 may be retracted (to allow for pivotal movement of the upper frame portion relative to the lower frame portion) via a retracting device or mechanism. For example, the control panel or handlebars may include a lever that an operator may pull or move to pull or move a cable or linkage to retract the locking element from one of the frame portions so that the upper frame portion may be pivoted relative to the lower frame portion. When the lever is released or returned to its initial position, the biasing element or spring may bias or urge the locking element to its locking position to lock the upper frame portion relative to the lower frame portion. Other means or mechanisms for selectively limiting pivotal movement of the upper frame portion relative to the lower frame portion may be implemented without affecting the scope of the present invention.

Optionally, the wheels 22 of the wheeled support unit may be otherwise turned (such as via a motor or motors at one or both of the wheel support posts 30 that cause pivotal movement or steering of the wheels) to steer the wheeled support unit in response to a user input or control at a control panel or at the handlebars 26 or via other steering devices or mechanisms or means. In such applications, the upper frame portion may not be pivotally mounted to the lower frame portion, whereby an operator may only actuate a control switch or button or input to cause the steering of the wheels of the support unit. The wheeled support unit may include a means or element or mechanism for selectively limiting rotation or pivotal movement or steering of the wheels at each wheel support post or the like.

The hose moving device 10 thus comprises a walk-behind machine with two rubber-tired wheels. Power for driving the hydraulic motors may be provided via any known power source or power means, such as via a gasoline powered internal combustion engine or the like (although other power means, such as electric motors, diesel engines or the like may be implemented without affecting the scope of the present invention). The wheeled support unit 12 may include the mechanical frame and components, a supply of hydraulic fluid or oil in a reservoir, a hydraulic pump, control valves, hydraulic pressure lines, and an electrical system including a battery and charging system. The hose moving device of the present invention may utilize aspects of various wheeled devices, such as screeding devices, such as, for example, the Somero Copperhead Laser Screed machine and/or Copperhead XD Laser Screed machine, which are commercially available from Somero Enterprises, Inc. of Houghton, Mich., and which are described in U.S. Pat. No. 6,953,304 and/or U.S. patent applications, Ser. No. 10/266,305, filed Oct. 2, 2002, now U.S. Pat. No. 6,976,805; and/or Ser. No. 10/902,528, filed Jul. 29, 2004, now U.S. Pat. No. 7,121,762 (Attorney Docket SOM01 P-326), which are hereby incorporated herein by reference in their entireties.

Grasping and lifting device 14 is mounted to or attached to the wheeled support unit 12 and is operable to lower the grasping device 16 toward and into engagement with the concrete supply hose via elevation device 18 and to cause the grasping device 16 to grasp the concrete supply hose. When the grasping device 16 has engaged and grasped or clamped onto the concrete supply hose, the elevation device 18 may raise or elevate or lift the grasping device 16 and the concrete supply hose grasped therein so that at least a portion of the concrete supply hose or section of hose is lifted above the ground. The wheeled support unit 12 may then be driven or controlled to move and steer over the support surface to move the concrete supply hose or section of hose to a new or targeted location. In the illustrated embodiment, a grasping and lifting device 14 is positioned at or near each of the opposite ends of the wheeled support unit 12, such as at opposite ends of a generally horizontal, longitudinal beam or member 40 (or two separate members that extend from opposite sides of the cross member 28) that extends both forwardly and rearwardly from cross member 28 of lower frame portion 20b of frame 20. The length of the longitudinal member or members may be selected depending on the particular application so as to provide the desired spacing of the grasping and lifting devices at or near the opposite ends of the wheeled support unit, in order to assist in balancing the wheeled support unit during operation thereof. The grasping and lifting devices 14 may operate together or independently to grasp and lift a hose or section of hose at the opposite end regions of the wheeled support unit 12. The two spaced apart grasping and lifting devices function to grasp spaced apart portions of the concrete supply hose to substantially lift or elevate a section or portion of the supply hose above the ground or support surface so that the hose or portion of the hose may be readily moved over and along the support surface.

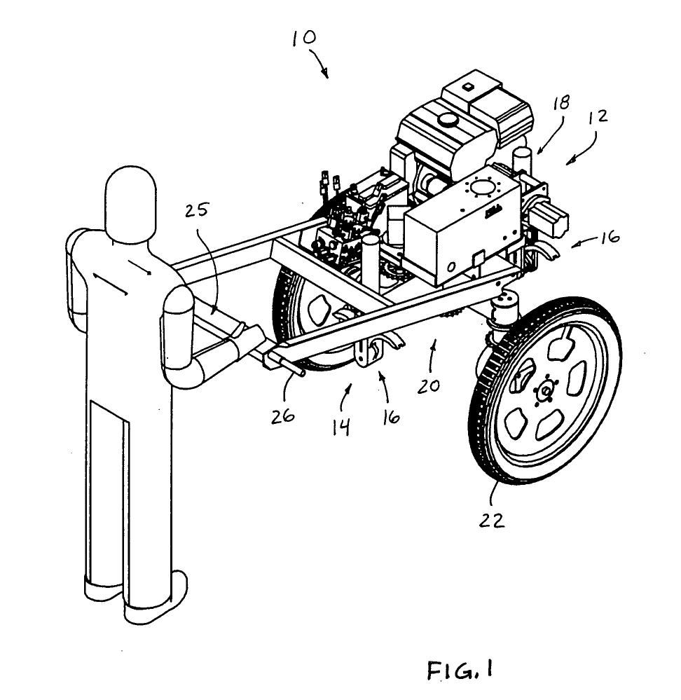

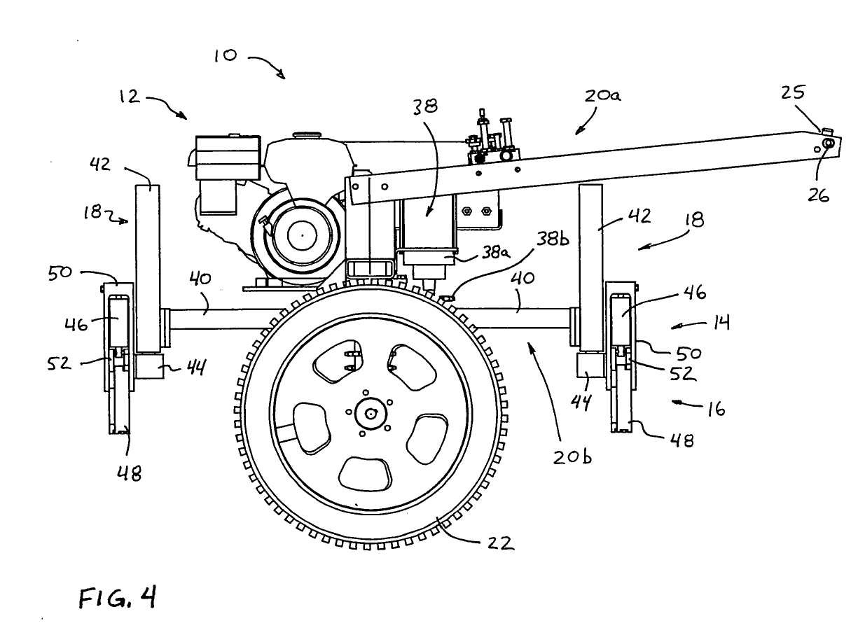

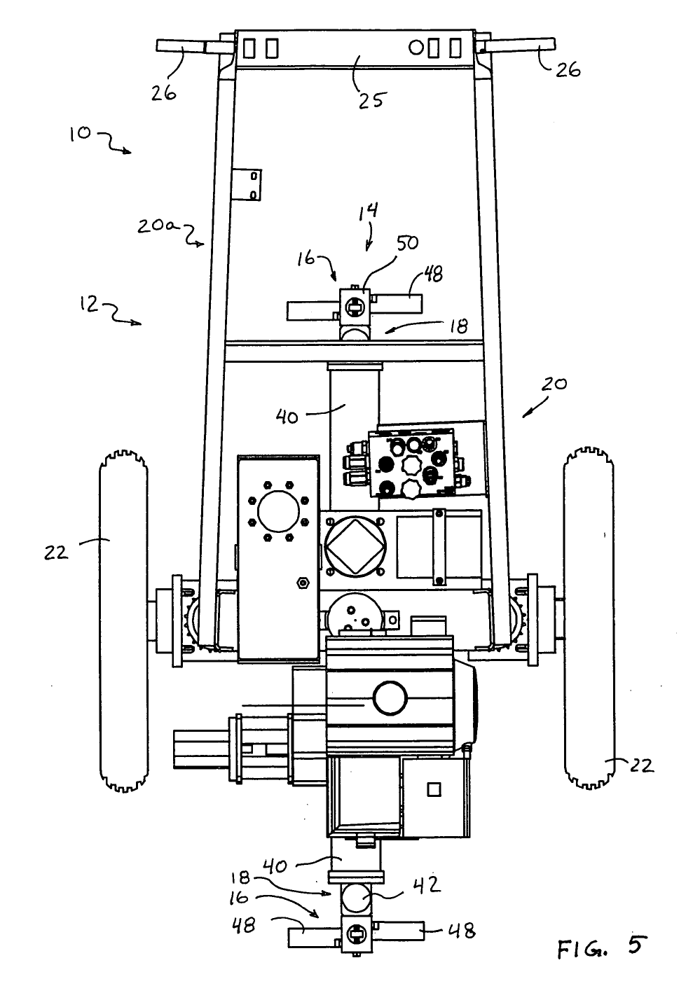

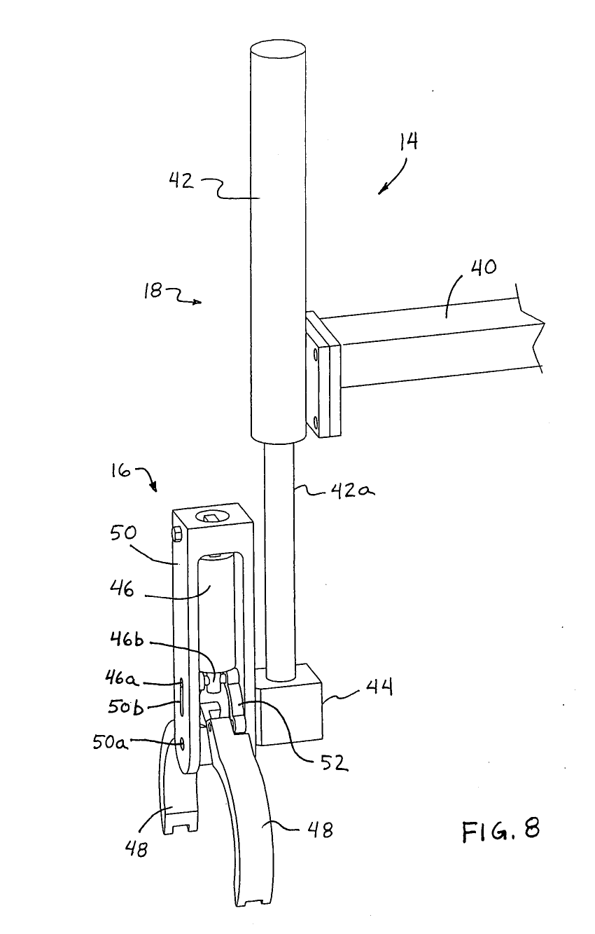

In the illustrated embodiment, each lifting device or elevation device 18 of the respective grasping and lifting device 14 is mounted at a respective end of the longitudinal member 40 and comprises a generally vertically oriented actuator 42, such as a linear actuator or a hydraulic cylinder or the like, with a mounting block or bracket or element 44 at a lower end of the actuator 42 (such as at the lower or outer end of a piston rod 42a of the hydraulic cylinder). Preferably, the actuator 42 provides for generally vertical movement of the mounting element 44 and limits or substantially precludes rotation of the mounting element about a generally vertical or longitudinal axis of the actuator 42 (this may be accomplished via any know means, such as pins/grooves/keys within a hydraulic cylinder and along which corresponding pins/groove/keys of a piston rod may slide to limit rotation of the piston rod within the cylinder). The extension and retraction of the actuator 42 causes a generally vertical movement of the mounting element 44, upon which the grasping device 16 is mounted, to vertically move or raise and lower the grasping device 16 between a raised position or orientation (such as shown in FIGS. 1-7) and a lowered position or orientation (such as shown in FIG. 8). The actuator 42 may be selectively controlled to selectively raise and lower the grasping device 16, such as in response to a user input or the like at the control panel 25 or handlebar 26 of the wheeled support unit 12. For example, an operator may toggle or actuate a toggle switch or the like at the control panel to selectively extend and retract the actuator to lower and raise the grasping device when desired.

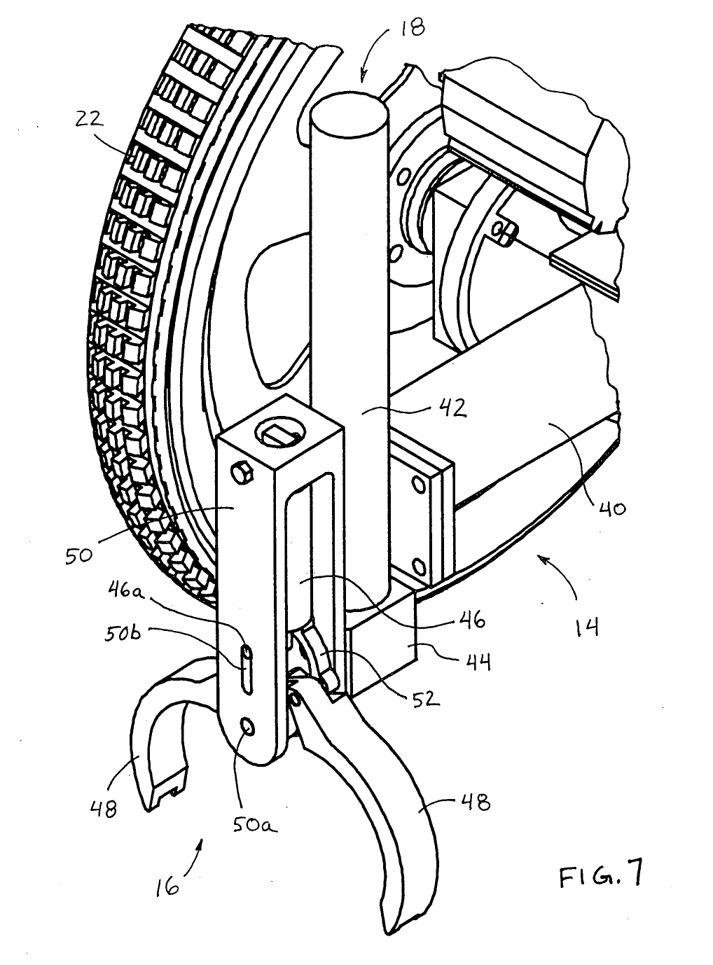

As best shown in FIGS. 7 and 8, grasping device 16 includes an actuator 46 that is operable to selectively pivot a pair of curved or arcuate arms or elements or sections 48, which are pivotally attached to a mounting bracket or element 50 (although only one grasping device is shown in FIGS. 7 and 8, the other grasping device of the wheeled device may be substantially similar to the illustrated grasping device). In the illustrated embodiment, actuator 46 (such as a hydraulic cylinder with an extendable and retractable piston rod 46b) is positioned within the generally U-shaped mounting bracket 50 and is connected to a pair of linkages 52, with each linkage 52 being pivotally connected at one end to a pin 46a at the end of piston rod 46b and at the other end to a respective curved grasping element 48. As can be seen in FIGS. 7 and 8, the grasping elements 48 may be pivotally mounted to a lower end of bracket 50 at a pivot pin 50a, while the lower end of the actuator 46 (at which the upper ends of the linkages are connected) may be guided via the guide or pivot pin 46a moving along a generally vertical slot 50b in the walls of the bracket 50 to maintain the movement of the actuator 46 in a generally vertical direction. Actuator 46 may be selectively operable to extend and retract to move linkages 52 to cause the grasping elements 48 to pivot and move between an open or disengaged or non-grasping position or orientation (as shown in FIG. 3) and a closed or engaged or grasping position or orientation (not shown). The actuator 46 may be selectively actuated in response to a user input at the control panel 25 or handlebar 26 or may be automatically activated in response to one or more control signals to close and open or grasp and release a hose or portion of hose. For example, an operator may toggle or actuate a toggle switch or the like at the control panel to selectively extend and retract the actuator to open and close the grasping device when desired.

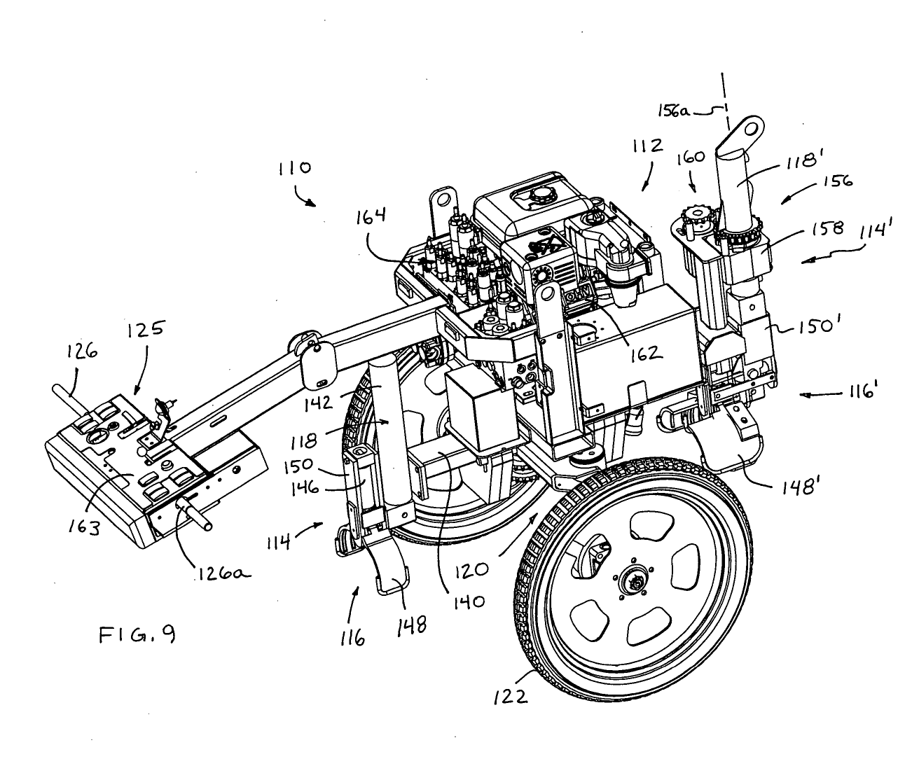

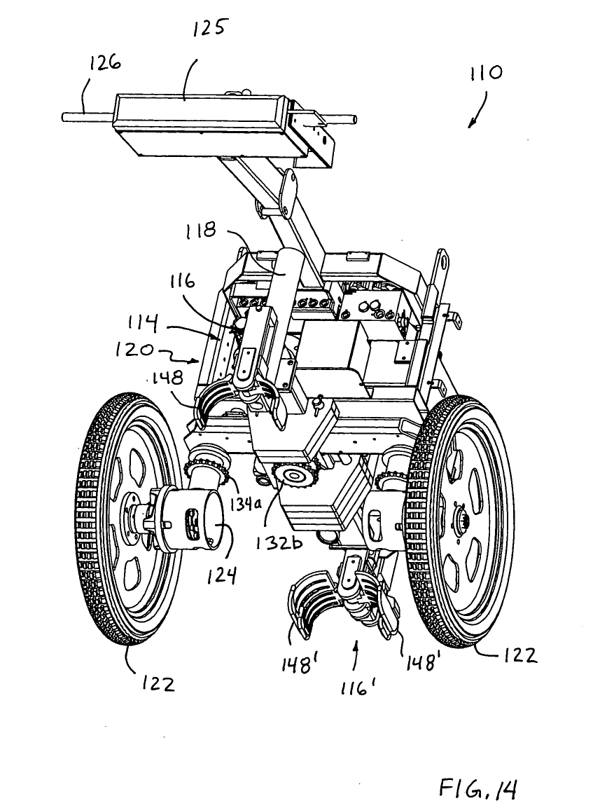

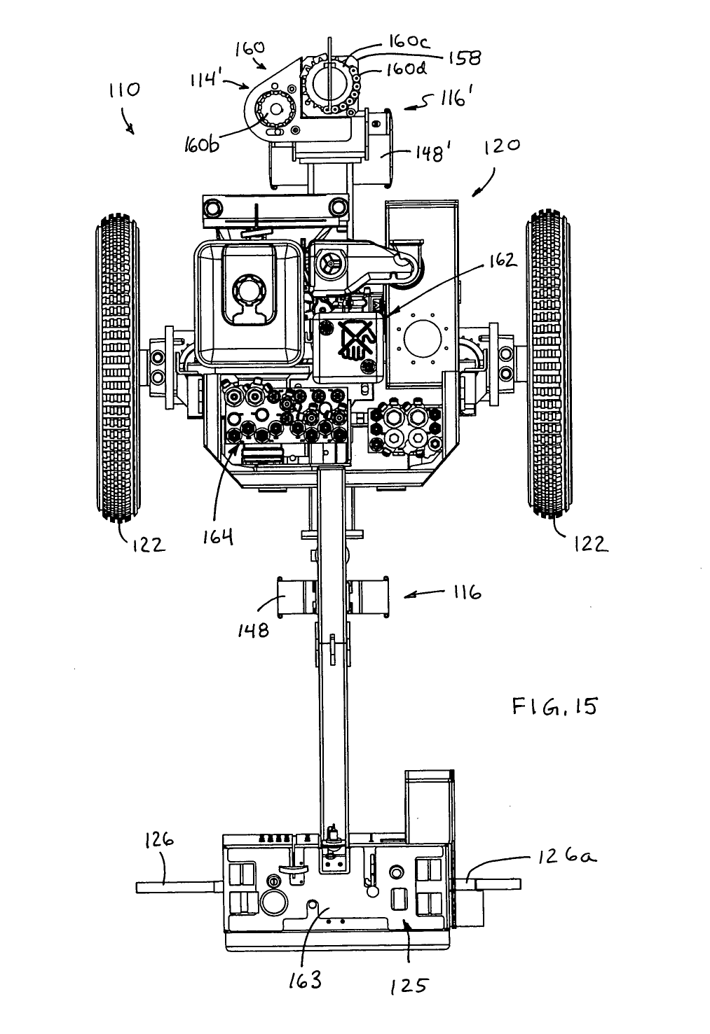

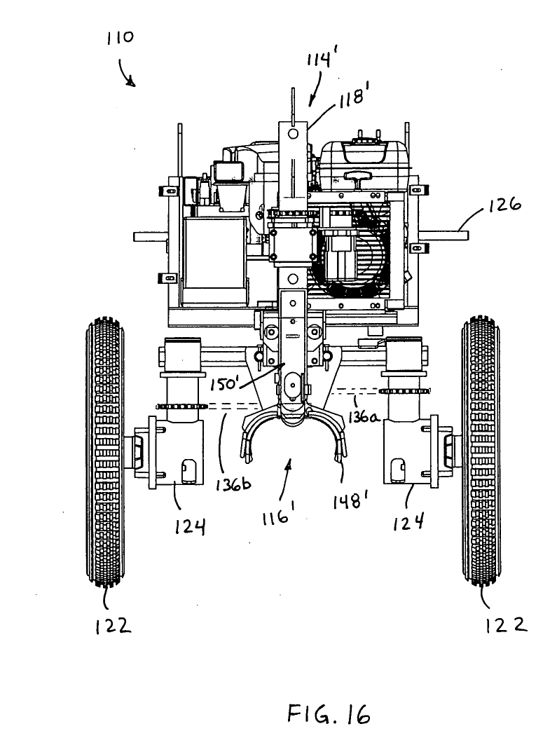

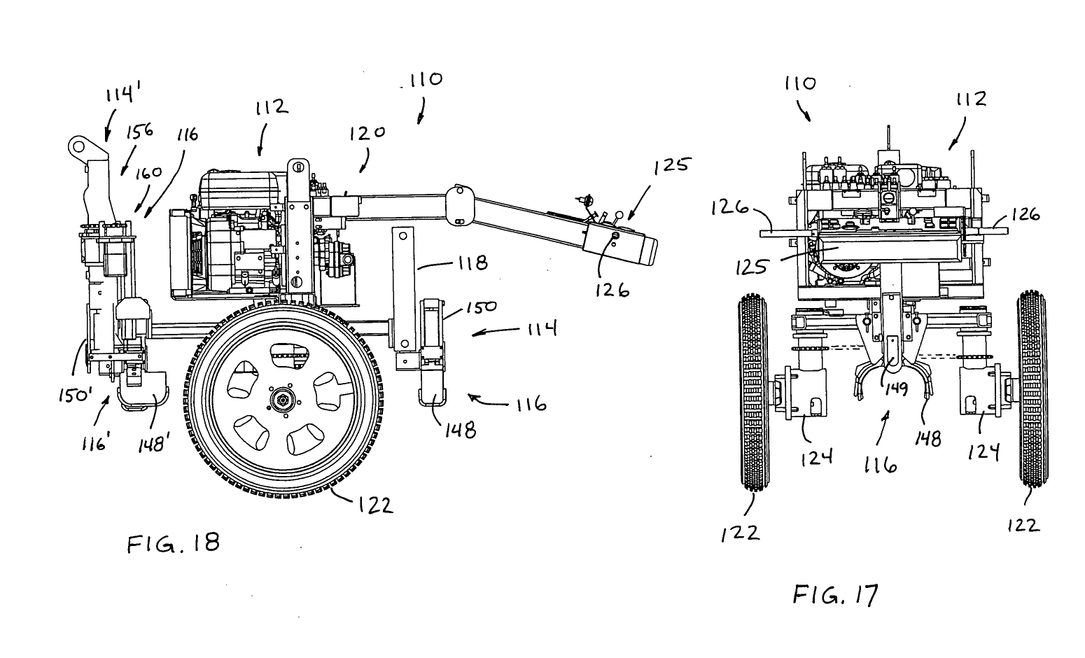

Optionally, and with reference to FIGS. 9-18, a wheeled hose moving device or apparatus or machine 110 is operable to grasp and move a concrete supply hose or section of hose, such as in a similar manner as discussed above. The wheeled hose moving device 110 includes a wheeled support or base unit 112 and at least one hose grasping and lifting device or mechanism or apparatus (in the illustrated embodiment, wheeled hose moving device 110 includes two grasping and lifting devices 114, 114′, one at or near each end of the wheeled support unit 112) that is/are movably supported by wheeled support unit 112. Hose grasping and lifting device 114, 114′ includes a grasping device 116, 116′, which is generally vertically movable (such as via an elevation device or actuator 118, 118′) and is adjustable to engage and grasp a concrete supply hose and to lift or raise or generally vertically move the concrete supply hose, such as in a similar manner as discussed above.

The wheeled hose moving apparatus or device or machine 110 thus may be substantially similar to wheeled hose moving apparatus or device or machine 10, discussed above, such that a detailed discussion of the wheeled hose moving devices or machines need not be repeated herein. The substantially similar or common elements or components of the wheeled hose moving devices or machines are shown with the same reference numbers in the drawings, except that the reference numbers of FIGS. 9-18 have 100 added to them.

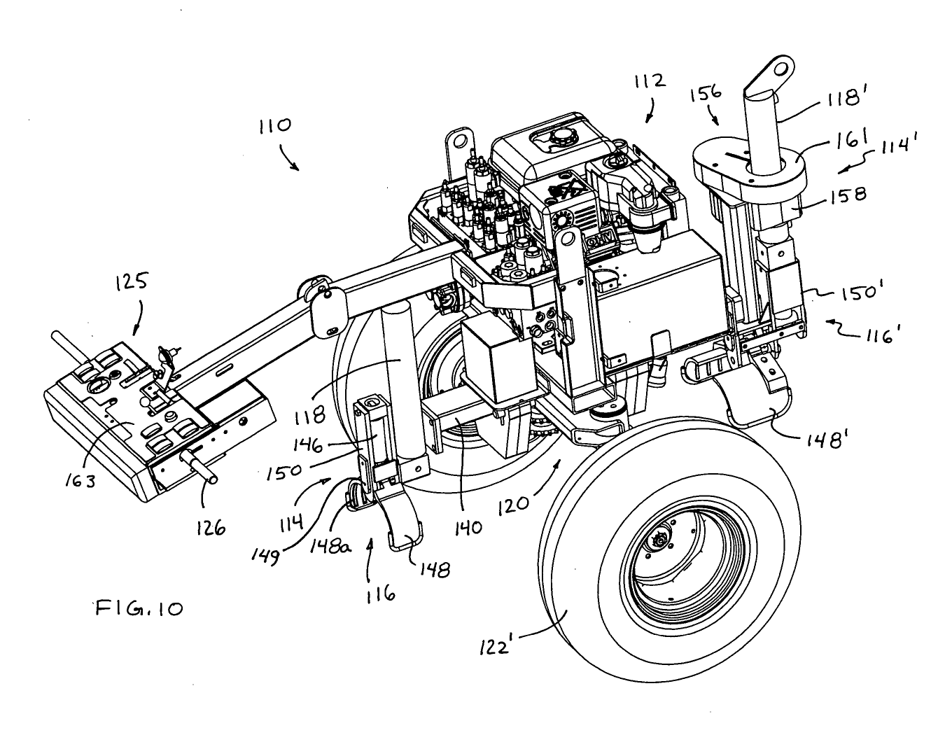

The wheeled support unit 112 may be driven and steered by an operator walking behind the wheeled unit to move the lifted concrete supply hose to a desired or appropriate or targeted location. Wheeled support unit 112 includes a frame portion 120 supported by a pair of rubber-tired wheels 122. In the illustrated embodiment of FIGS. 9 and 14-18, hose moving apparatus 110 includes thin tires 122 for movably supporting and moving the hose moving apparatus 110 over the support surface. Optionally, and such as shown in FIG. 10, the hose moving apparatus 110 may include low pressure inflatable wide tires 122′ to provide a wider foot print of the apparatus as it is moved over the support surface. The particular tires for the hose moving apparatus may be selected depending on the particular application of the hose moving device and without affecting the scope of the present invention.

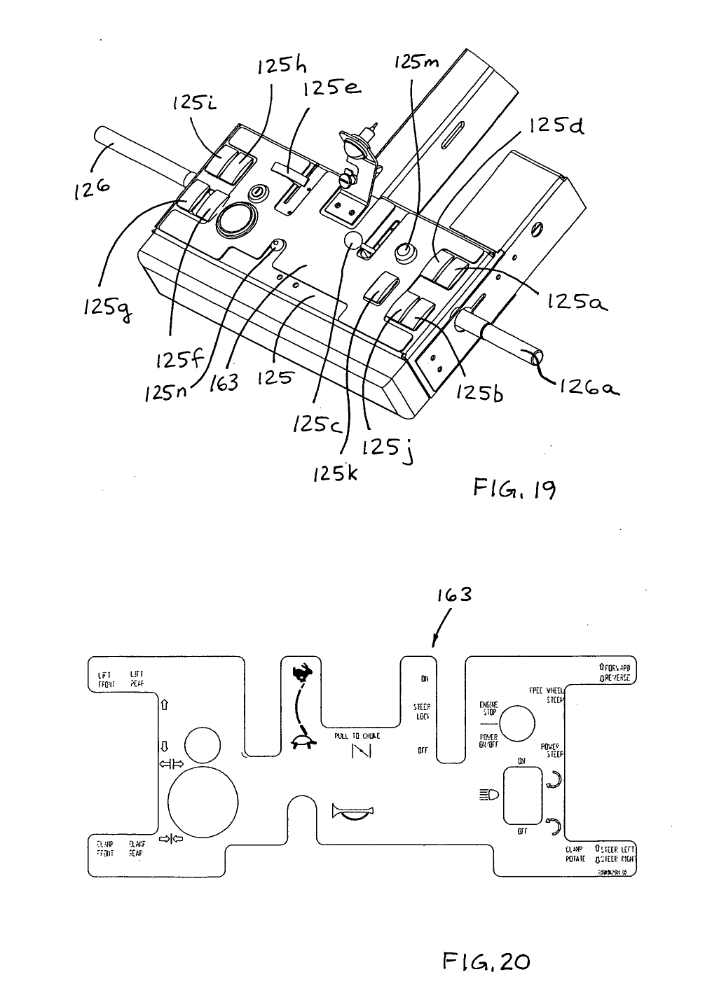

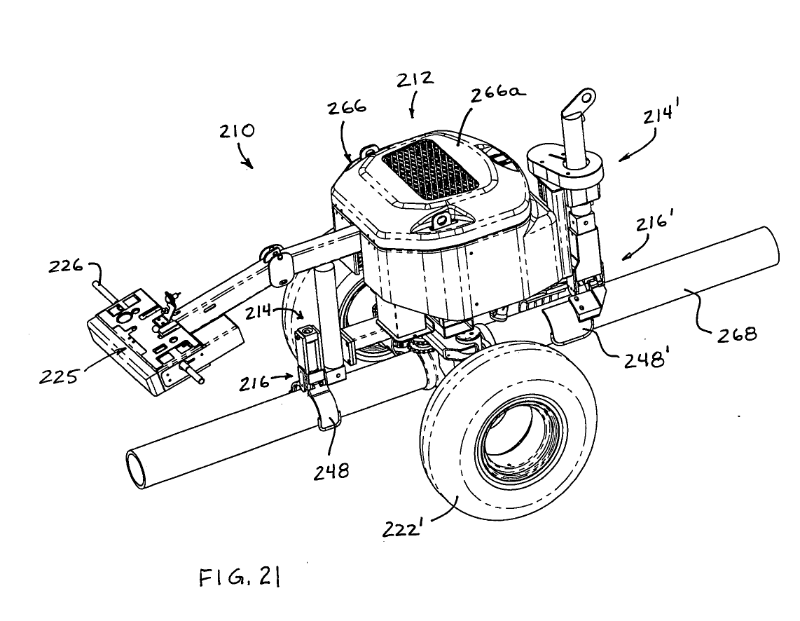

The wheels and tires may be rotatably driven via respective drive motors 124, such as hydraulic motors or the like, to provide driving of the apparatus over and through the uncured concrete or subgrade materials. The drive motors 124 may be actuated and deactuated and controlled via a user input or control at a control panel 125 and/or handlebars 126 of the wheeled support unit 112. For example, and with reference to FIGS. 19 and 20, an operator may actuate or toggle a user input or switch 125a at control panel 125 to select a forward or reverse driving direction, and may actuate or toggle a user input or switch 125b at control panel 125 to steer the apparatus in either direction. Optionally, the operator may lock or unlock the steering function (so as to selectively lock the wheels at a desired direction or orientation) via actuation of a selector switch 125c at control panel 125, and/or may elect a free wheel steer function that allows the wheels to substantially freely pivot about their vertical pivot axes via actuation or toggling of a user input or toggle switch 125d at control panel 125. Further, an operator may control the speed (in either the forward or reverse direction) of the apparatus via a speed control 126a at one of the handlebars 126 and/or a throttle control 125e at the control panel 125. The throttle control 125e may control the engine RPMs to control the power or output of the engine, while the speed control 126a at handlebars 126 may control the propulsion speed of the drive motors (such as by twisting the inner handlebar portion forward to increase the propulsion speed to move faster and twisting the inner handlebar portion rearward to decrease the propulsion speed to move slower).

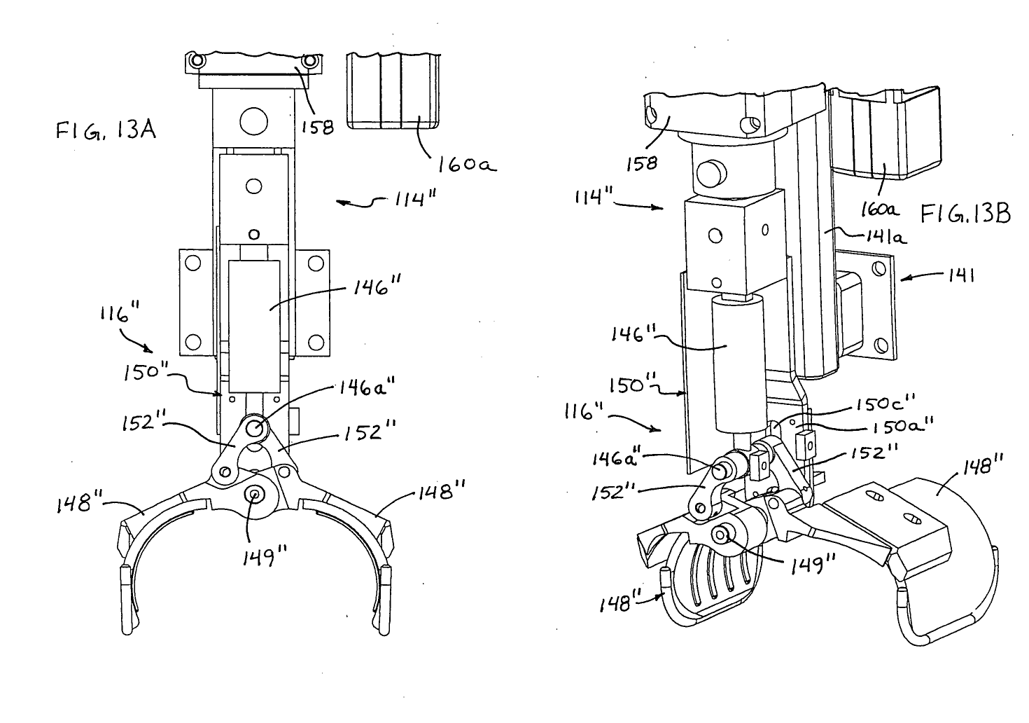

Hose moving device or apparatus 110 includes a hose grasping and lifting device 114 and hose grasping device 116 at or near its rear end (toward the control panel and handlebars of the apparatus) for grasping and lifting a section of hose. Hose grasping device 116 is vertically adjustable via elevation device or actuator 118, which may comprise a hydraulic actuator having a cylinder 142 attached to a longitudinal beam or member 140, and an extendable/retractable piston rod that extends downwardly from cylinder 142 to lower the grasping elements 148 toward a hose at the support surface and that retracts upwardly into cylinder 142 to raise the grasping elements 148 and to lift the hose above the support surface. Hose grasping and lifting device 114, including actuator 118 and the grasping elements 148 and actuator 146, may be substantially similar in operation to hose grasping and lifting device 14, discussed above, such that a detailed discussion of the hose grasping devices need not be repeated herein. Briefly, actuator 146 is positioned within the generally U-shaped mounting bracket 150 and is connected to a pair of linkages or arms (although not shown in FIGS. 9-18, the linkages or arms may be substantially similar to linkages or arms 152″ discussed below with respect to FIGS. 13A and 13B) pivotally connected to a respective curved grasping element 148, which is pivotally attached to mounting bracket 150 via a pivot pin or axle or element 149. As can be seen in FIGS. 9, 10 and 14, hose grasping elements 148 may include ribs 148a along their inner curved surfaces to enhance gripping of the supply hose when the grasping elements are closed or clamped around the supply hose.

In the illustrated embodiment of FIGS. 9-18, wheeled hose moving apparatus 110 also includes a forward hose grasping and lifting device 114′ and associated hose grasping device 116′ at or near its forward end (opposite the control panel 125 and handlebar 126 of hose moving apparatus 110). Hose grasping device 116′ includes arcuate or curved grasping elements 148′, which may be similar to or substantially the same as grasping elements 148 or may be wider (as shown in FIGS. 9-16) than grasping elements 148 (or could be narrower if desired), while remaining within the spirit and scope of the present invention. An actuator 146′ is positioned within a generally U-shaped mounting bracket 150′ and is connected to a pair of linkages or arms (not shown for hose grasping device 116′, but the linkages or arms may be similar to those shown in FIGS. 13A and 13B and discussed below with respect to hose grasping device 116″) via a pivot pin 146a′, which is slidably or movably mounted to and/or guided by slots at the lower ends of the plates 150a′, 150b′ of bracket 150′, as discussed below.

Hose grasping device 116′ is rotatable about a generally vertical pivot axis 156a of hose grasping and lifting device 114′ via a pivot mechanism or device 156 that is selectively operable to pivot the grasping elements 148′ in a left or right direction to turn the grasping elements and the hose supported thereby as the apparatus is moved and steered over the support surface. The wider dimension of grasping elements 148′ may be desired for the pivotable hose grasping device 116′ to impart a curve or bend in the supply hose when the hose grasping device 116′ is rotated, without kinking or pinching the supply hose supported by the grasping elements 148′. As can be seen in FIGS. 9-14, hose grasping elements 148′ may include ribs 148a′ along their inner curved surfaces to enhance gripping of the supply hose when the grasping elements are closed or clamped around the supply hose.

In the illustrated embodiment, and as best shown in FIGS. 11A-F, 12A and 12B, hose grasping and lifting device 114′ is mounted to a mounting structure 141, which is attached to a forward end or portion of frame 120 of hose grasping apparatus 110 and which includes a generally vertical mounting member or element 141a. A mounting collar or sleeve bearing 158 is attached at an upper end of mounting member 141a and rotatably receives actuator 118′ therein, whereby a cylinder 142′ of actuator 118′ is rotatably received at mounting collar 158 and is substantially non-vertically movable within mounting collar 158. For example, the cylinder 142′ may be substantially secured or clamped at an inner bearing portion of the mounting collar 158, whereby the inner bearing portion is rotatable about the vertical axis relative to an outer bearing portion of the mounting collar to rotate the cylinder 142′ while limiting or substantially precluding vertical movement of the cylinder 142′.

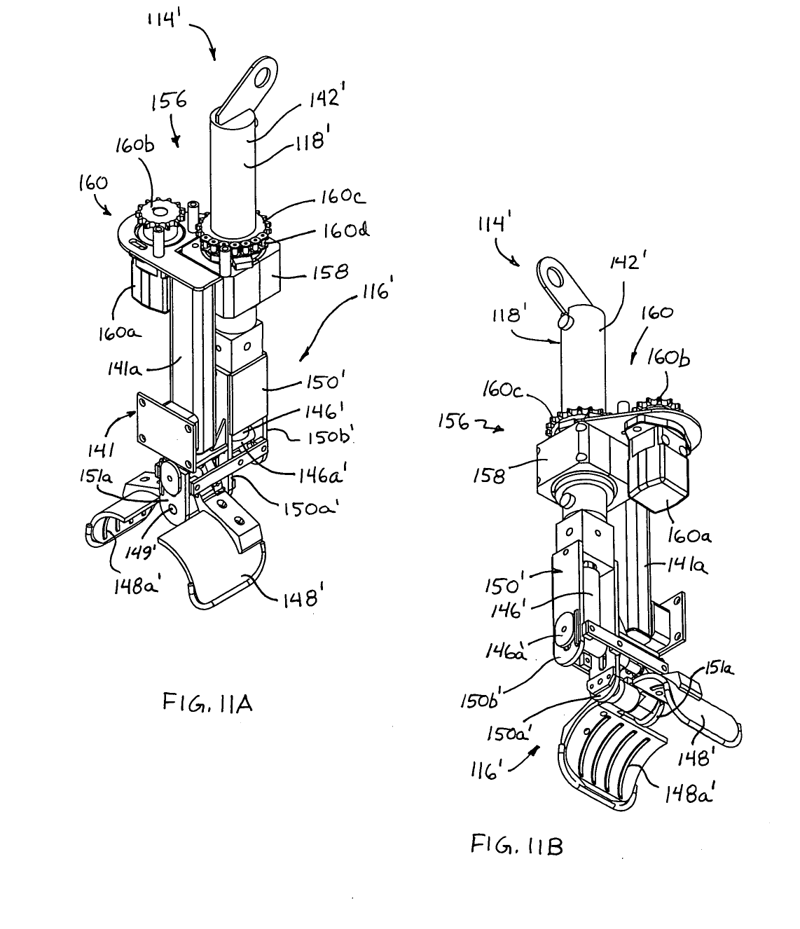

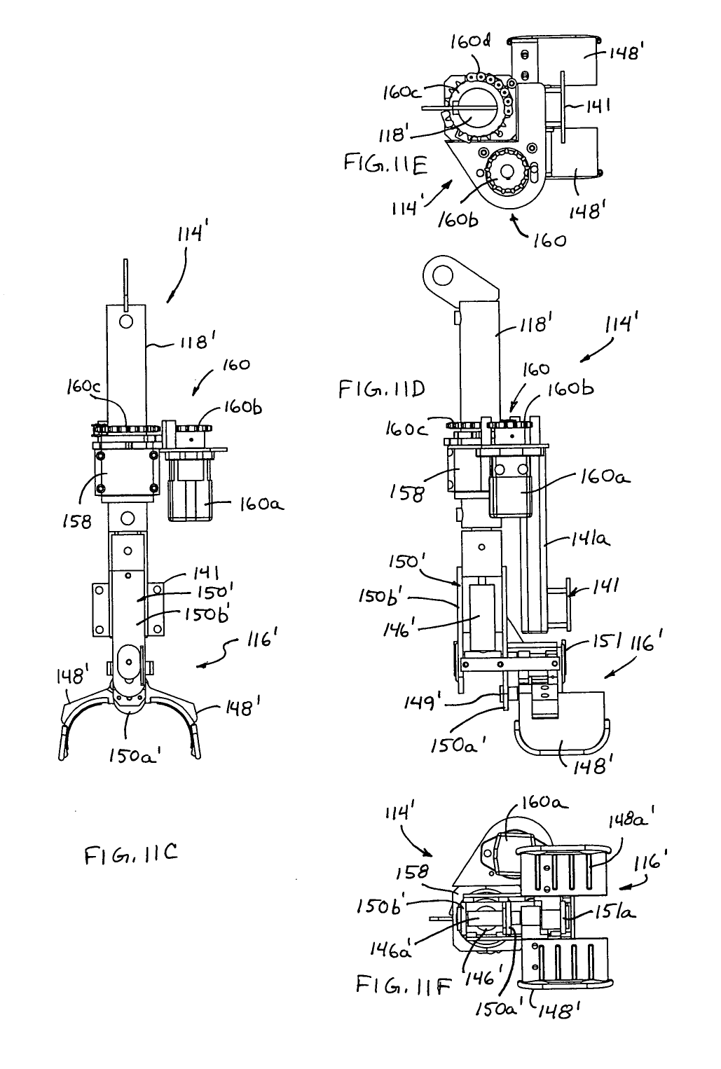

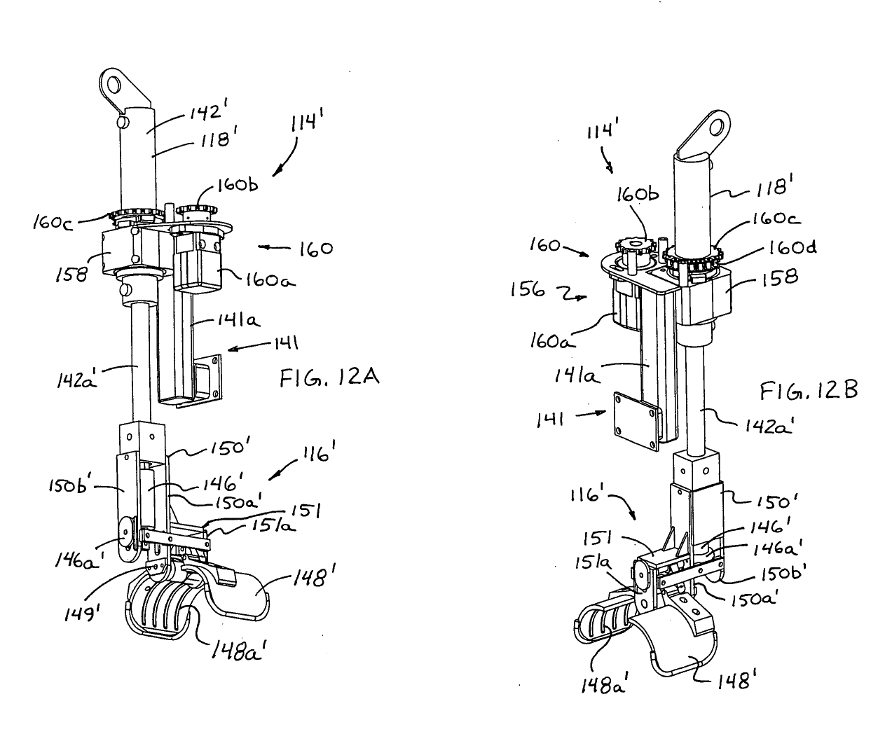

Actuator 118′ includes a piston rod 142a′ (FIGS. 12A and 12B) that is vertically extendable/retractable relative to cylinder 142′ to lower/raise hose grasping device 116′ and grasping elements 148′, such as in a similar manner as described above. The mounting bracket 150′ is attached at the lower end of piston rod 142a′ and supports actuator 146′, which is extendable and retractable to impart pivotal movement of grasping elements 148′ about a pivot pin 149′, such as in a similar manner as described above. In the illustrated embodiment, the grasping elements 148′ are pivotally mounted at a mounting bracket 151 that is laterally offset (such as toward the rear of the apparatus) at the lower portion of mounting bracket 150′, whereby extension and retraction of actuator 146′ causes substantially vertical movement of a generally horizontally oriented actuating element 146a′ that extends forwardly from actuator 146′ and engages and pivots the pivot pins or linkages or arms that cause the pivotal movement of grasping elements 148′ of hose grasping device 116′. The grasping elements 148′ may be offset toward the rear of the apparatus to shorten the distance between the front and rear grasping elements, and/or to assist in balancing the wheeled hose moving device by adjusting the support location along the hose, and/or to limit or adjust the bend or curve imparted on the supply hose during operation of the hose moving device. Thus, the location or degree of offset of the grasping elements 148, 148′ may be selected depending on the particular application of the hose moving device, while remaining within the spirit and scope of the present invention.

In the illustrated embodiment, and as can be seen with reference to FIGS. 11A, 11B, 12A and 12B, mounting bracket 150′ of hose grasping device 116′ includes a longer rearward wall 150a′ that is spaced from and extends downward further than a forward wall 150b′ of bracket 150′. Bracket 151 is mounted at the longer rearward wall 150a′ and includes a generally vertical rearward wall 151a that is spaced from rearward wall 150a′ of bracket 150′. Grasping elements 148′ are pivotally mounted at and between the lower ends of rearward walls 150a′ and 151a via pivot pin 149′, while actuating element 146a′ extends through brackets 150′, 151 so as to be positioned at a lower end of actuator 146′ and at an upper end or above grasping elements 148′. Forward wall 150b′ and rearward walls 150a′ and 151a of brackets 150′, 151 are slotted to allow for generally vertical movement of actuating element 146a′, whereby such vertical movement of actuating element 146a′ (in response to vertical extension/retraction of actuator 146′) causes pivotal movement of grasping elements 148′ (such as via pivot arms or elements pivotally mounted at bracket 151 and actuating element 146a′ in a similar manner as described below).

Hose grasping and lifting device 114′ of wheeled hose moving apparatus 110 further includes a rotatable drive device 160 at mounting collar 158. Rotatable drive device 160 is operable to rotate actuator 118′ about its generally vertical axis relative to collar 158 to pivot or turn the hose grasping device 116′ and grasping elements 148′ toward one side or the other. In the illustrated embodiment, rotatable drive device 160 includes a rotational drive motor 160a (such as a hydraulic motor or the like), which drives a rotatable sprocket 160b, which in turn rotates another rotational sprocket 160c at actuator 118′ via a drive chain or member 160d (only a portion of the chain is shown in FIGS. 11A, 11E and 12B for purposes of clarity of the drawings). Thus, the hose moving apparatus is selectively operable to rotate or pivot the grasping elements 148′ to the left or right as the apparatus is moved and steered along and over the support surface. Optionally, and as shown in FIG. 10, a cover or casing 161 may be provided to substantially encase the sprockets 160b, 160c and chain 160d for safety purposes and to limit or reduce the exposure of the components to dirt and/or other debris or environmental elements.

The actuators 146, 146′ of hose grasping devices 116, 116′ are independently and selectively operable to extend and retract to move the linkages to cause the grasping elements 148, 148′ to pivot and move between an open or disengaged or non-grasping position or orientation and a closed or engaged or grasping position or orientation. Further, the actuators 118, 118′ of hose grasping and lifting devices 114, 114′ are independently and selectively operable to raise and lower the respective grasping devices and grasping elements to engage and disengage a supply hose. The actuators 146, 146′ may be selectively actuated in response to a respective user input at the control panel 125 or handlebar 126 or may be automatically activated in response to one or more control signals to close and open or grasp and release a hose or portion of hose. For example, an operator may toggle or actuate a toggle switch 125f (FIG. 19) or the like at the control panel 125 to selectively extend and retract the actuator 146 to open and close the rearward grasping elements 148 when desired, and may toggle or actuate a switch 125g or the like to selectively extend and retract actuator 146′ to open and close the forward grasping elements 148′ when desired. Similarly, an operator may toggle or actuate a toggle switch 125h to raise and lower the rearward grasping device 116 (via retraction/extension of actuator 118) when desired and/or may toggle or actuate a toggle switch 125i to raise and lower the forward grasping device 116′ (via retraction/extension of actuator 118′) when desired. The operator may also selectively rotate or pivot the grasping elements 148′ to the left or right via actuation of a user input or toggle switch 125j at the control panel 125 and/or in conjunction with steering the apparatus in either direction.

Optionally, the forward hose grasping device may not include an offset of the grasping elements, and thus may have non-offset grasping elements such as in a similar manner as the hose grasping devices 16 and 116 discussed above (depending on the desired separation distance between the forward and rearward hose grasping devices). For example, and as shown in FIGS. 13A and 13B, a forwardly positioned hose grasping device 116″ of a hose grasping and lifting device 114″ for a wheeled concrete supply hose moving device of the present invention may be similar to hose grasping device 116′, discussed above, but may not include the offset mounting bracket 151′ and offset grasping elements 148′ of hose grasping device 116′, and may instead pivotally mount a pair of grasping elements 148″ directly or substantially directly below an actuator 146′, such as in a similar manner as in the case of hose grasping device 116 discussed above. In the illustrated embodiment of hose grasping device 116″, actuator 146″ is positioned within the generally U-shaped mounting bracket 150″ and is connected to a pair of linkages or arms 152″ via a pivot pin 146a″, which is slidably or movably mounted to and/or guided by slots formed or established at the lower ends of the plates of bracket 150″ (such as a slot 150c″ of plate 150b″ of bracket 150″ shown in FIG. 13B). The opposite ends of arms 152″ are pivotally connected to the respective curved grasping elements 148″, which are pivotally attached to mounting bracket 150″ via a pivot pin or axle or element 149″. Thus, extension and retraction of actuator 146″ moves arms 152″ vertically (as the pivot pin 146a″ moves along the slots formed in the bracket 150″), whereby downward movement of arms 152″ (via extension of actuator 146″) causes pivotal movement of the grasping elements 148″ toward the open or hose receiving orientation, while upward movement of arms 152″ (via retraction of actuator 146″) causes pivotal movement of grasping elements 148″ toward the closed or clamping or grasping orientation.

The construction and operation of the hose grasping device 116″ and hose grasping and lifting device 114″ may be otherwise substantially similar to the construction and/or operation of the hose grasping device 116′ and hose grasping and lifting device 114′ discussed above and below, such that a detailed discussion of the hose grasping devices and hose grasping and lifting devise need not be repeated herein. The similar or common components and/or elements of the devices are shown in FIGS. 9-18 with like reference numerals. The hose grasping device 116″ is shown in FIGS. 13A and 13B without one of the plates of the bracket 150″ so as to show additional details of the pivot arms, but preferably would include the other plate of the bracket 150″ such as in a similar manner as bracket 150′ shown in FIGS. 11A-F, 12A and 12B.

As can be seen with reference to FIGS. 19 and 20, wheeled hose moving apparatus 110 may include a cover plate or panel or label 163 at control panel 125 to provide indication as to what function is associated with the switches and buttons and levers and other inputs at the control panel. Optionally, control panel 125 may provide controls or inputs for other features or functions, such as lights (such as via user input or switch 125k), an emergency stop (such as via stop or kill switch or button 125m), a horn or alert function (such as via user input or button 126n) and/or the like, without affecting the scope of the present invention.

Thus, the drive motors and actuators of the wheeled hose moving apparatus 110 may be independently driven and controlled via user inputs, such that an operator may control and/or steer the wheeled support unit 112 as it is driven and moved over the surface. Optionally, and desirably, the drive motors may comprise hydraulic motors and the actuators may comprise hydraulic cylinders that are powered via an engine 162, which powers a hydraulic pump to pump pressurized fluid to the appropriate or selected motor or actuator via solenoids or control valves 164 (which are selectively actuatable/deactuatable via the controls or inputs at the control panel 125) at frame 120 of apparatus 110. Optionally, the wheel drive motors 124 may be differentially powered so as to adjust the power or pressure at each drive motor so as to limit slippage of one or both of the wheels as the wheeled support unit is driven along the support surface and/or over the concrete supply hose at the support surface.

Although shown and described as having a rotatable or pivotable hose grasping device 116′ at a forward end of the hose moving apparatus 110 and a generally non-rotatable hose grasping device 116 at a rearward end of the hose moving apparatus, it is envisioned that either or both (or none) of the hose grasping devices of the hose moving apparatus may be selectively rotated about a generally vertical axis to turn the respective hose grasping elements as the hose moving apparatus is moved and steered along the support surface. The rotation of the hose grasping devices may ease movement of the supply hose over the support surface and/or may ease the alignment of the grasping elements with the hose to ease grasping of the hose and picking up of the hose for movement of the hose over the support surface. Optionally, the rotation of the grasping device may be performed in conjunction with the steering or turning of the wheels of the apparatus to ease movement of the hose without kinking the hose or causing sharp bends in the hose as the hose is moved over the support surface.

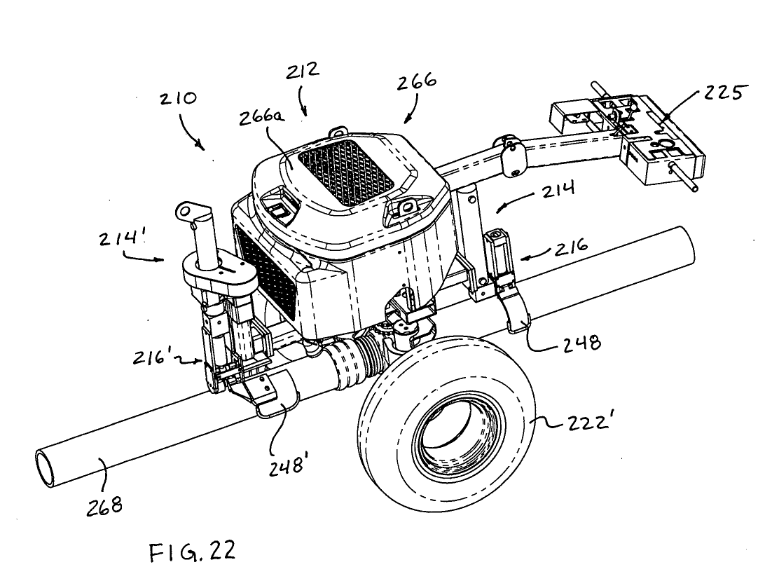

Optionally, and as shown in FIGS. 21 and 22, a wheeled hose moving device 210 of the present invention may include an outer casing 266 that substantially encases the motor and internal components of the hose moving device, in order to reduce noise during operation of the hose moving device, and/or to limit a person from contacting the motor or other components (which may be moving or may become heated during operation of the hose moving device) during use. Optionally, the outer casing or housing 266 may comprise a fiberglass housing, and may have an upper cover 266a that is removable or movable to facilitate access to the engine and motors of the hose moving device, if desired.

The wheeled hose moving or hose support unit or device 210 may be substantially similar to the wheeled hose moving devices 10, 110, 110′, discussed above, such that a detailed discussion of the hose moving devices need not be repeated herein. The common or similar components or elements of the hose moving devices are shown in FIGS. 21 and 22 with like reference numbers as used in FIGS. 9-20, but with 100 added thereto. In the illustrated embodiment, the hose moving device 210 is shown with the low pressure inflatable wide tires 222′ to provide a wider foot print of the apparatus as it is moved over the support surface. However, the hose moving device may otherwise include thin tires for movably supporting and moving the hose moving device over the support surface, depending on the particular application of the hose moving device.

Accordingly, and as can be generally seen with reference to FIGS. 21 and 22, the hose moving device or apparatus (such as hose moving device 210 of FIGS. 21 and 22) of the present invention may be driven to a location so that the hose grasping elements 248, 248′ are generally above a concrete supply hose or section of hose 268. The hose grasping elements may then be lowered (such as in response to a user input) to be at or near the level of the hose or section of hose 268 and may be closed (such as in response to a user input) to grasp or clamp onto the hose. The hose grasping elements may then be raised (such as in response to a user input) to lift the hose or at least a portion of the hose above the support surface (such as shown in FIGS. 21 and 22), whereby the wheeled support unit 212 of hose moving device 210 may be driven and steered to move the hose to a new or targeted location. While the wheeled unit is moved to the new or targeted location, the grasping elements may be pivoted to reduce kinking or bending of the concrete supply hose as the wheeled unit and concrete supply hose is moved to the new or targeted location. When the wheeled unit is at the new or targeted location, the grasping elements and the hose grasped thereby may be lowered (such as in response to a user input) to be at or near the support surface. The grasping elements may then be opened (such as in response to a user input) to release the hose and the grasping elements may then be raised (such as in response to a user input) to disengage from the hose, whereby the wheeled unit may be moved away from the moved and newly positioned hose. The wheeled unit may be moved to another section of hose to repeat the process if desired.

During operation of the wheeled hose moving device, the operator may generally balance the two wheeled support unit as the support unit is moved over and along the support surface or subgrade surface. Optionally, the wheeled support unit may include three or more wheels and may include an operator support stand, whereby the movable hose moving device may provide a ridable hose moving device.

Therefore, the present invention provides a wheeled or movable hose moving device that is operable to be driven to a desired location along a concrete supply hose and to grasp and lift the concrete supply hose and to move the concrete supply hose to and lower and release the concrete supply hose at a new or targeted location. The wheeled hose moving device is operated by an operator that may walk behind the wheeled support unit and that may selectively drive and control the hose moving device. The hose moving device of the present invention thus may readily lift and move a concrete supply hose or section of hose with little manual labor or effort on the part of the operator of the hose moving device.

Changes and modifications in the specifically described embodiments may be carried out without departing from the principles of the present invention, which is intended to be limited only by the scope of the appended claims, as interpreted according to the principles of patent law.

1. A wheeled hose moving device that is movable over a support surface and that is operable to grasp and lift and move a concrete supply hose at the support surface, said wheeled device comprising:
a wheeled support, said wheeled support including a frame portion and a pair of wheels rotatably mounted at said frame portion;
a hose grasping device movably supported by said wheeled support, said hose grasping device including a pair of arms that are generally vertically movable relative to said frame portion and that are movable relative to one another; and
said wheeled support being positionable generally at a concrete supply hose and said hose grasping device being lowerable to a level generally at the concrete supply hose, said arms being movable to engage and grasp the concrete supply hose, said hose grasping device being operable to lift the grasped concrete supply hose, whereby the grasped and lifted concrete supply hose is movable over the support surface by said wheeled support.

2. The wheeled hose moving device of claim 1, wherein said wheeled support is selectively movable in a forward direction and a rearward direction.

3. The wheeled hose moving device of claim 1, wherein said wheeled support powered via at least one drive motor.

4. The wheeled hose moving device of claim 1, wherein said hose grasping device is selectively vertically movable via an actuator.

5. The wheeled hose moving device of claim 4, wherein said arms are moved relative to one another via another actuator.

6. The wheeled hose moving device of claim 1, wherein said arms are pivotally movable relative to one another and are pivotable between an open orientation, where said arms may be vertically moved downward toward a hose, and a grasping orientation, where said arms engage and grasp the hose for lifting and moving the hose.

7. The wheeled hose moving device of claim 6, wherein said arms are pivotally movable relative to one another via an actuator.

8. The wheeled hose moving device of claim 7, wherein said arms are pivotally movable via pivotable linkages engaged with said actuator and an upper portion of said arms.

9. The wheeled hose moving device of claim 7, wherein said arms comprise oppositely curved grasping elements that grasp a generally cylindrical hose when in said grasping orientation.

10. The wheeled hose moving device of claim 1 further comprising a second hose grasping device having a pair of arms, said hose grasping devices being at or near opposite end portions of said frame portion and at opposite sides of said wheels.

11. The wheeled hose moving device of claim 1, wherein said hose grasping device is pivotable about a generally vertical pivot axis.

12. The wheeled hose moving device of claim 1, wherein said wheels of said wheeled support are pivotable about respective generally vertical axes to steer said wheeled support over the support surface.

13. The wheeled hose moving device of claim 12, wherein said frame portion of said wheeled support includes an upper frame portion that is pivotally attached to a lower frame portion, said wheels being rotatably mounted to said lower frame portion.

14. The wheeled hose moving device of claim 13, wherein pivotal movement of said upper frame portion relative to said lower frame portion imparts a pivotal movement of said wheels about the respective generally vertical axes to steer said wheeled support.

15. A method for grasping and lifting and moving a concrete supply hose at a support surface, said method comprising:
providing a wheeled device, said wheeled device including a wheeled support having a frame portion and a pair of wheels rotatably mounted at said frame portion, said wheeled device including a hose grasping device movably supported by said wheeled support, said hose grasping device including a pair of arms that are generally vertically movable relative to said frame portion and that are movable relative to one another;
positioning said wheeled support at an initial location that is generally at a concrete supply hose;
lowering said hose grasping device to a level generally at the concrete supply hose;
moving said arms to engage and grasp the concrete supply hose;
lifting said hose grasping device and the grasped concrete supply hose;
moving said wheeled support to move the grasped and lifted concrete supply hose over the support surface; and
lowering and releasing the concrete supply hose at a location that is remote from the initial location.

16. The method of claim 15, wherein moving said wheeled support comprises moving said wheeled support via at least one drive motor.

17. The method of claim 15, wherein lowering and lifting said hose grasping device comprises lowering and lifting said hose grasping device via an actuator.

18. The method of claim 17, wherein moving said arms comprises moving said arms relative to one another via another actuator.

19. The method of claim 15, wherein moving said arms comprises pivotally moving said arms relative to one another between an open orientation, where said arms may be vertically moved downward toward a hose, and a grasping orientation, where said arms engage and grasp the hose for lifting and moving the hose.

20. The method of claim 19, wherein pivotally moving said arms comprises pivotally moving said arms relative to one other via an actuator.

21. The method of claim 20, wherein said arms comprise oppositely curved grasping elements that grasp a generally cylindrical hose when in said grasping orientation.

22. The method of claim 15, wherein said wheeled device comprises two hose grasping devices at or near opposite end portions of said frame portion and at opposite sides of said wheels.

23. The method of claim 15 including pivoting said hose grasping device relative to said frame portion about a generally vertical pivot axis.

24. The method of claim 15, wherein moving said wheeled support includes steering said wheels of said wheeled support.

25. The method of claim 24, wherein said wheeled support includes an upper frame portion that is pivotally attached to a lower frame portion, said wheels being rotatably mounted to said lower frame portion and pivotable about respective generally vertical axes relative to said lower frame portion.

26. The method of claim 25, wherein steering said wheels includes pivoting said upper frame portion relative to said lower frame portion, whereby pivotal movement of said upper frame portion relative to said lower frame portion imparts a pivotal movement of said wheels about the respective generally vertical axes.
